(19) United States
(12) Patent Application Publication
(10) Pub. No.: US 2004/0090104 A1
(43) Pub. Date: May 13, 2004

(54) FOUR WAY ADJUSTABLE ARMREST

(75) Inventor: Kurt Seibold, South Lyon, MI (US)

Correspondence Address: FOLEY & LARDNER, 150 WEST JEFFERSON AVENUE, SUITE 1000, DETROIT, MI, 48226-4443, US

(73) Assignee: Johnson Controls Technology Company

(21) Appl. No.: 10/292,566

(22) Filed: Nov. 12, 2002

(51) Int. Cl. B60N 2/46; A47C 7/54

(52) U.S. Cl. 297/411.35; 297/411.36; 297/411.38

(57) ABSTRACT

A four way adjustable armrest for use on a vehicle seat includes an arm support member having a extension member and the armrest is connected to a seat back including a pair of toothed track members extending along the seat back. A toothed gear is movable on the extension member of the armrest between an engaging position where the armrest position is locked and a retracted position where the gear teeth are removed from the toothed track members and the armrest is free to rotate and to translate along the track members via a track follower. The gear has a splined inner diameter and is carried on mating splines on an outer surface of the cylindrical extension member. A pivoting actuating member moves or throws the gear on the splined extension member between the engaged and retracted positions.

### FIELD OF THE INVENTION

The present invention relates generally to armrests for vehicle seats and more particularly, the present invention relates to a low cost fully adjustable armrest for use with a vehicle seat wherein the armrest can be moved to varying rotational and vertical positions using a simple mechanism.

### BACKGROUND OF THE INVENTION

It is known to provide an armrest for use on a vehicle seat. It is also known to provide an adjustable armrest utilizing a variety of mechanisms for adjusting the armrest. For example, it is known to have the armrest pivot to a position generally aligned with the seat back. Further, it is known to have the armrest move vertically with respect to the seat. For example, a variety of patents disclosure various mechanisms for providing such adjustment, including: U.S. Pat. No. 4,657,305, to Meiler, which discloses an armrest for use on a seat wherein this armrest can be rotated and translated with respect to the seat back. U.S. Pat. No. 4,659,135, to Johnson, discloses an adjustable armrest for use on a interior panel on a door of a vehicle wherein the adjustable armrest uses a rack and pall mechanism for adjusting the vertical height of the armrest. The Johnson reference further discloses that dual rack and pall mechanisms may be provided to also allow for angular adjustment of the armrest.

Additionally, it is also well known to provide an armrest for use in a vehicle wherein the armrest can be both rotated and translated such as disclosed in U.S. Pat. No. 4,674,790, to Johnson. The '790 Johnson reference discloses that it is known to have a biased adjustable armrest such that upon release of a locking member, the armrest is biased upward. The '790 Johnson reference also discloses the use of a pall and ratchet for adjusting the angular position of the armrest. The pall and ratchet operate such that the armrest may be rotated in one direction to be adjusted and the pall must be released in order to rotate the armrest in the opposite direction. Thus, the '790 Johnson reference discloses and teaches that separate structure must be used to provide both the rotating and translating functions of the armrest adjustment mechanism. U.S. Pat. No. 5,636,899, to Shifadal, discloses a pneumatically operated kinematic structure for a vehicle armrest which also biases the armrest in a given direction. U.S. Pat. No. 5,765,919, to Carlson, et al., discloses an adjustable armrest lock mechanism wherein the armrest may be unlocked to be moved by rotating the arm support member to release the lock and then once the arm support is repositioned, the armrest support is rotated in the opposite direction to lock the arm support member in place. Similarly, U.S. Pat. No. 5,941,603, to Grammar, discloses an armrest member which is capable of being height adjusted. Accordingly, despite the significant efforts to provide a low cost and simple adjustable armrest, there remains a continued need and desire to improve the existing designs.

In particular, the prior art structures need continued improvement to reduce costs and complexity associated with such mechanisms. Further, the prior art lacks the ability to have a four way adjustable armrest which is efficiently and cost-effectively integrated into a vehicle seat. Further, the prior art designs are insufficient in their ability to widely adjust to accommodate the varying sizes of the occupants in a seat. Additionally, the prior art does not disclose adjustable armrests that can be positioned both vertically and angularly to a desired position.

### SUMMARY OF THE INVENTION

In one embodiment of the present invention, there is included an adjustable armrest for connection with a vehicle seat, the adjustable armrest includes an armrest support member including a splined extension member located proximate one end thereof. The adjustable armrest further includes a gear, such as a ring gear, located on the extension member of the armrest support member, the gear includes a splined inner surface and a toothed outer surface, the gear further includes oppositely located extension members. In one embodiment of the present invention, the oppositely located extension members extending in opposite directions along the same line and extend outward from the outer periphery of the gear.

In one embodiment of the present invention, the adjustable armrest is connected to a track including a pair of toothed racks connected to the side of a seat back of a vehicle seat by having an end of the extension member of the armrest support member connected to a slider connected to the racks of the track member of the seat back. In one embodiment, the toothed outer surface of the ring gear engages the teeth of the racks to lock the adjustable armrest in position.

An actuator member having a pivot portion located on a side thereof is connected proximate the splined extension member of the armrest support member and the actuator member includes a pair of leg extensions cooperating with the extension members of the gear such that when the actuator member is pivoted against the arm support member, the leg extensions of the actuator member translate or throw the gear on the splines of the extension member of the armrest support member to retract the gear teeth on the outer periphery of the gear from the teeth on the racks allowing the arm support member to rotate and/or to translate along the track with the slider connected to the end of the splined extension member of the armrest support member. Accordingly, by selectively activating the actuator, an occupant of the seat can position the armrest member in any one of a number of selected angular positions and may also selectively position the arm support member at a given height.

In an alternate embodiment of the present invention, the armrest support member includes a biasing member connected to the slider to bias the slider in a predefined direction along the track. In particular, the biasing member is preferably a spring having one end connected to the slider and the other end connected to the seat back of the vehicle seat. In one alternate embodiment of the present invention, the biasing member is in compression and biases the slider and the armrest support member upward against the arm of the vehicle seat occupant. In another alternate embodiment of the present invention, the spring is in extension and pulls the slider and armrest support member upward along the track against the arm of the vehicle seat occupant.

One feature of the present invention is the provision of a four way adjustable armrest which is capable of providing both pivotal and height adjustment to an armrest support member wherein the adjustable arm support includes a minimum of components. It is a further feature of the present invention to provide an adjustable armrest support mechanism which is capable of providing the above object and can be done at a relatively very low cost.

It is a further feature of the present invention, to provide an adjustable armrest support mechanism which can be made entirely out of plastic materials and is capable of meeting all manufacturer and legally mandated requirements.

Alternatives to the features of the invention will be apparent to those skilled in the art after reviewing the present application. Such alternative ways are intended to fall within the scope of the present invention if they fall within the scope of the claims which follow.

### BRIEF DESCRIPTION OF THE DRAWINGS

FIG. 1 is a perspective view of a four way adjustable armrest support mechanism according to the present invention;

FIG. 2 is a side view of the four way adjustable arm support mechanism of FIG. 1;

FIG. 3 is a top view of the four way adjustable arm support mechanism of FIG. 1;

FIG. 4 is an exploded perspective view of the four way adjustable armrest support mechanism of FIG. 1;

FIG. 5 is a partial, cross-sectional view taken in the direction of the arrows of the line 5-5 in FIG. 2;

FIG. 6 is a partial, cross-sectional view taken in the direction of the arrows of the line 6-6 in FIG. 2;

FIG. 7 is a partial, perspective view of the four way adjustable armrest mechanism of FIG. 1 showing the detail of the adjuster and actuator member according to the present invention; and

FIG. 8 is an partial, plan view of the four way adjustable armrest mechanism as shown in FIG. 7.

### DETAILED DESCRIPTION OF THE PREFERRED EMBODIMENTS

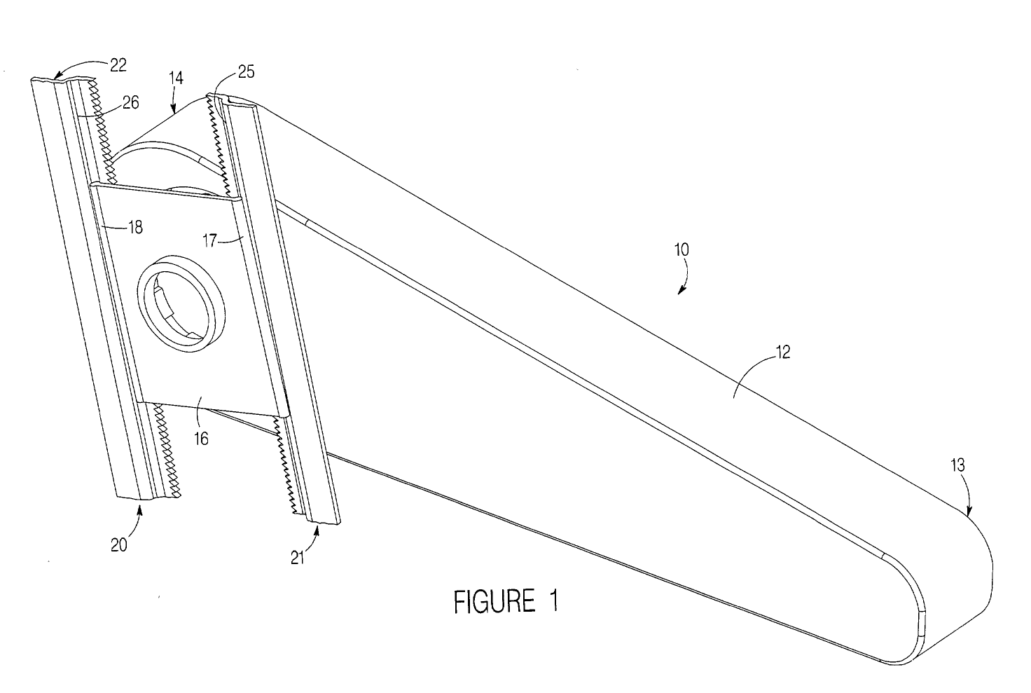

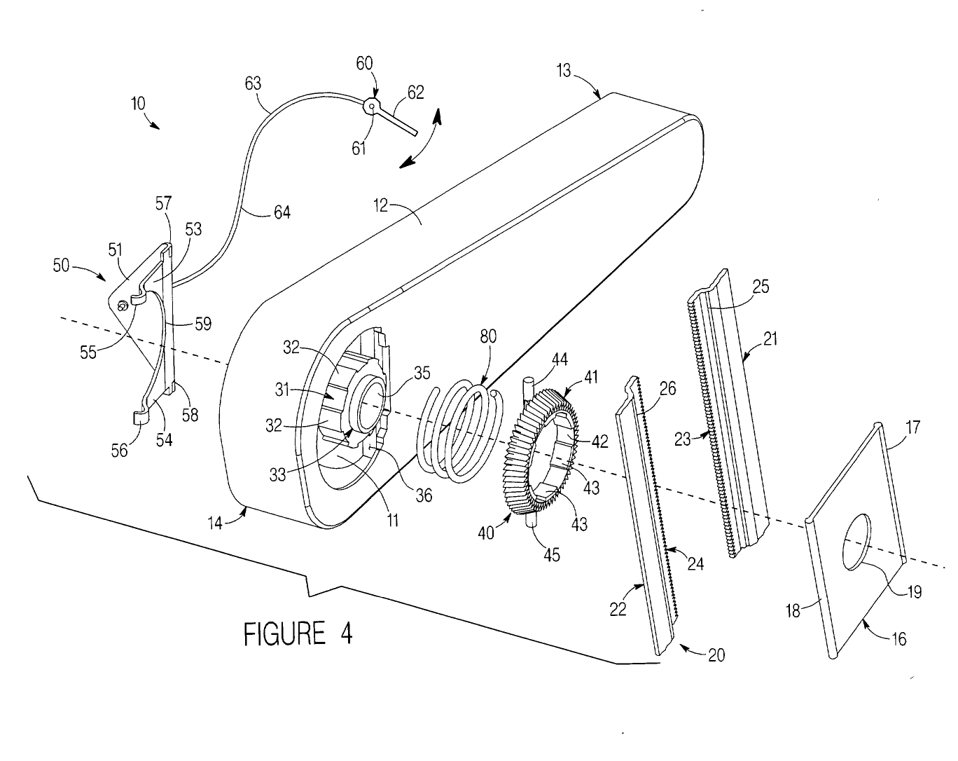

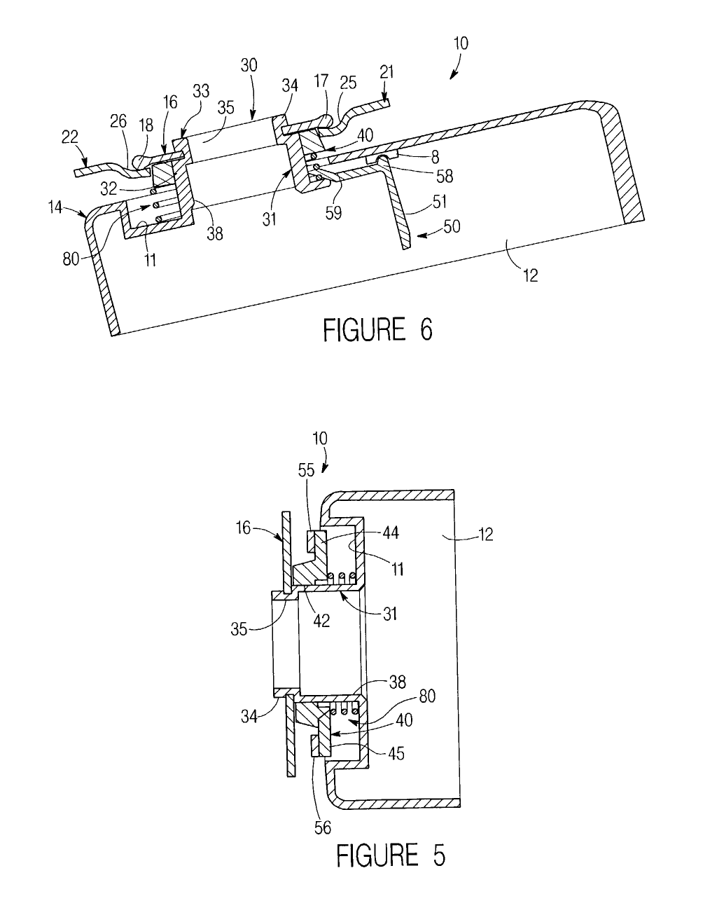

Referring generally to FIGS. 1 through 8, and in particular to FIG. 1, there is shown an adjustable arm support mechanism 10 including an arm support member 12 having a first end 13 and a second end 14. The arm support member 12 is preferably made from a high strength plastic material such as a nylon, ABS modified polycarbonate or other appropriate material. Further, the arm support member 12 may be covered using any known or appropriate cover material (not shown) and may similarly be padded using a foam material or the like as desired.

The arm support member 12 is connected to a track 20. The track includes a pair separated and opposing racks 21 and 22. A slider 16 is connected to an extension member 30 of the arm support member 12. The slider 16 is preferably a substantially planer member or piece having a substantially rectangular shape. The slider member 16 includes a pair of opposing side edges 17 and 18 each having a thickened cross-section as compared to the body of the slider 16 and preferably a substantially curved or rounded shape. Each of the racks 21 and 22 of the track 20 preferably have a s-shaped form and include a dwell 25 and 26, respectively. For example, the dwell 25 of the rack 21 of the track 20 has a concave shape located along the respective length of the rack 21 for receiving the respective edge 17 of the slider 16. Similarly, the dwell 26 of the rack 22 receives the edge 18 of the slider 16.

The racks 21 and 22 are preferably connected to the seat back (not shown) of a vehicle seat (not shown) using any known or appropriate connection device such that the slider can translate along the racks 21 and 22. The racks 21 and 22 may also extend for any given appropriate distance as may be desired for a particular application.

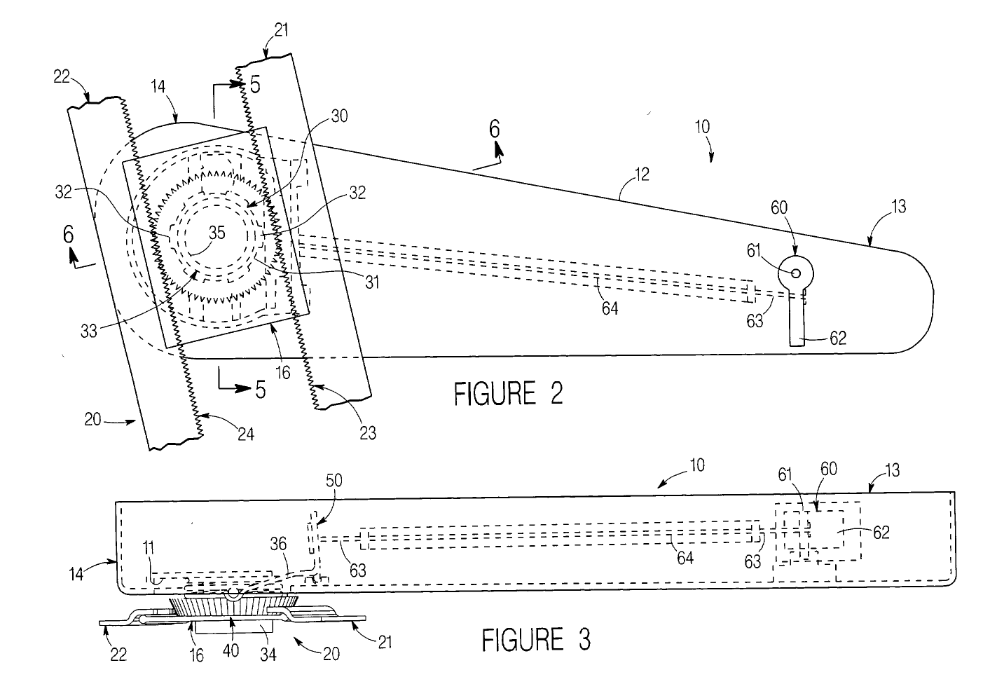

Referring more particularly to FIGS. 2 through 4, the adjustable arm support mechanism 10 according to the present invention is shown in further detail. In particular, it should be noted that the racks 21 and 22 of the track 20 each include an edge thereof each having a row of teeth 23 and 24, respectively. The teeth 23 and 24 of the racks 21 and 22, respectively, preferably run substantially the entire length of the rack 21 and 22 but may alternatively be limited to a given distance thereon. Further, while the teeth 23 and 24 are shown has having a standard saw tooth design, it should be understood that any appropriate notch or profile of the teeth 23 and 24, may be chosen for the present application provided the profile of the teeth 23 and 24 function to lock the adjustable arm support mechanism 10 in a given position including the location both rotationally and vertically on the seat back.

The adjustable arm support mechanism 10 of the present invention further includes a gear or locking member 40. The locking member 40 has a substantially ring gear shape and includes an outer surface or periphery including teeth 41 extending the entire periphery of the locking member 40. However, it is possible to have the teeth 41 extend only a portion or portions of the periphery of the locking member 40. Thus, it should be understood that it is possible for the adjustable arm support mechanism to function properly within a limited range by selectively providing teeth 41 on the locking member 40.

Locking member 40 further includes an inner periphery 42 provided with a plurality of splines 43 located thereabout. It should be understood also that it is possible to provide the locking member 40 with a single spline 43 or similarly shaped element to prevent rotation of the locking member 40 on the extension member 30 of the arm support member 12 but that it is preferable to have a plurality of splines 43 to provide better operation and strength.

The locking member 40 further includes a first extension member 44 and an oppositely positioned and aligned second extension member 45. The extension members 44 and 45 project proximate the periphery of the locking member in aligned and substantially opposite directions and extend past the outer periphery of the locking member including past the teeth 41. The extensions members 44 and 45 preferably have a substantially cylindrical or rounded outer shape but may have any known or appropriate shape without departing from the broader aspects of the present invention.

The locking member 40 is preferably made from a high strength plastic material and is injection molded using any known or appropriate process. In particular, it is most preferable that the locking member 40 be made from a nylon or similar plastic material. However, it should be understood that the locking member 40 may alternatively be made from any known or appropriate material including from powdered or sintered metals from composites or from any combination of materials.

The arm support member 12 further includes, proximate the second end 14, the extension member 30 projecting from one side thereof. The extension member 30 has a generally cylindrical shape and is stepped in a portion thereof. The armrest support member 12 includes a recessed and sunken portion 11 on the one side thereof from which the extension member 30 extends. At one side of the portion 11 a passage or opening 36 is provided as will be more fully described below. The extension 30 includes a first cylindrical extension portion 31 having a substantially cylindrical cross-section and including a plurality of splines 32 disposed on the outer periphery thereof. The extension member 30 further includes a second cylindrical extension portion 33 extending preferably from the first cylindrical extension portion 31 and having an outer periphery 37 having a substantially round shape. The second cylindrical extension portion 33 preferably extends through the hole 19 in the slider member 16. The second cylindrical extension portion 33 includes an locking or enlarged outer diameter portion 34 extending beyond the hole 19 in the slider 16 to lock the extension member 30 to the slider 16. The locking portion 34 may be formed using any known or appropriate forming process. Alternatively, the slider member 16 may be otherwise fastened to the second cylindrical extension portion 33 using any known or appropriate manner for connecting the pieces provided the extension member 30 is connected or locked to the slider 16 but can still rotate with respect thereto. The first cylindrical extension portion includes a hole 38 and the second cylindrical extension portion 33 includes a hole 35 aligned with the hole 38 to provide a continuous passage between the two.

The locking member 40 is located on the first cylindrical extension portion 31 and to one side of the slider 16 such that the slider 16, locked to the second cylindrical extension portion 33, prevents the locking member 40 from sliding off of the cylindrical extension portion 31. The splines 43 of the inner diameter portion 42 of the locking member 40 are designed to mesh with or matingly engage the splines 32 of the outer periphery of the first cylindrical extension portion 31 such that the locking member 40 can translate along the first cylindrical extension portion 31 of the extension member 30. Further rotation of the arm support member 12 causes the extension member 30 to rotate as well as the locking member 40 provided the teeth 41 of the locking member 40 are not engaging the teeth 23 and 24 of the racks 21 and 22, respectively. If the teeth 41 of the locking member 40 are engaging the teeth 23 and 24 of the racks 21 and 22, respectively, the locking member 40 can not be rotated and hence neither can the arm support member 12 due to the engagement of the splines 43 and 32.

A spring or other biasing member 80 is provided between the locking member 40 and the sunken portion 11 to bias the locking member 40 into engagement with the track 20 causing the teeth 41 of the locking member 40 to engage the teeth 23 and 24 of the racks 21 and 22, respectively.

The adjustable arm support mechanism 10 of the present invention is provided with an actuator member or lever 50 for disengaging the locking member 40 from the track 20 against the bias force of the biasing member 80. The actuator member 50 includes a first portion or member 51 having a substantially planar and triangular shape and having a passage or hole 52 therein. The first portion 51 is connected with a first leg 53 and a second leg 54 in a substantially perpendicular configuration. The first leg 53 and second leg 54 each include a substantially curved shaped hook member 55 and 56, respectively located proximate an end distal from the first portion 51. Preferably, the shape of each hook member 55 and 56 is substantially rounded or curvilinear and chosen to be complimentary to the peripheral shape of the first extension member 44 and second extension member 45, respectively, of the locking member 40. The hook members 55 and 56 are intended to engage and capture the extension members 44 and 45, respectively and interact therewith for translating the locking member 40 along the first cylindrical extension portion 31 of the extension member 30 against the biasing force of the biasing member 80. Thus, the extension members 44 and 45 are positively engaged in the shaped portions of the hook members 55 and 56, respectively of the actuator member 50.

The actuator member 50 further includes a shaped edge 59 having a shape corresponding with the outer periphery of the extension member 30 so that each leg 53 and 54 of the actuator member 50 may engage and move the locking member 40 without the actuator member 50 interfering with the extension member 30. Accordingly, the shaped edge 59 preferably has a substantially rounded or constant curvilinear shape but may alternatively have any other known or appropriate shape for avoiding interference with the extension member 30 and which is capable of functioning to capture and move the locking member 40.

The actuator member 50 further includes a first pivot portion 57 located at one side of the actuator member 50 aligned with the first leg 53 and the actuator member 50 further includes a second pivot portion 58 located on the opposite side of the actuator member 50 and aligned with the second leg 54. The first and second pivot members 57 and 58, respectively, interact with a boss 8 of the armrest support member 12 located with respect to the hole 36 in the arm support member 12. The convex surface of the member 57 compliments and interacts with a concave surface and an end of the boss 8 in the armrest support member 12, such that the actuator member 50 freely pivots on the bosses 8 with respect to the armrest support member 12 and the extension member 30.

Accordingly, when the first portion member 51 of the actuator member 50 is moved in a first direction, the actuator member pivots on the bosses 8 and the first leg 53 and the second leg 54 also pivot with respect to the bosses 8 causing the locking member 40 to translate on the first cylindrical extension portion 31 of the extension member 30.

The adjustable armrest device 10 according to the present invention further includes an operating member 60 for operating the actuator member 50. The operating member 60 includes a handle 62 having a connector 61 for connection with the armrest support member 12. The connector 61 may be of any known or appropriate type. The operating member 60 further includes a cable 63 located in a sheath 64 for conveying movement of the handle 62 into movement of the actuator 50 in a well known manner. It should be appreciated that while the operating member 60 of the present invention is shown as including sheath 64 and cable 63 and a handle 62, any appropriate mechanism or alternative arrangement may be used for operating the actuator member 50 without departing from the scope of the present invention. For example, the actuator member 50 may be operated directly by the occupant engaging the first portion member 51. Additionally, the actuator member 50 may be operated using a rigid connector or the like in place of the cable 63 and sheath 64. Further, any other known mechanism or device may be used for operating the actuator member 50 provided such operating member 60 is capable of operating the actuator member 50 to engage and move the locking member 40 as described.

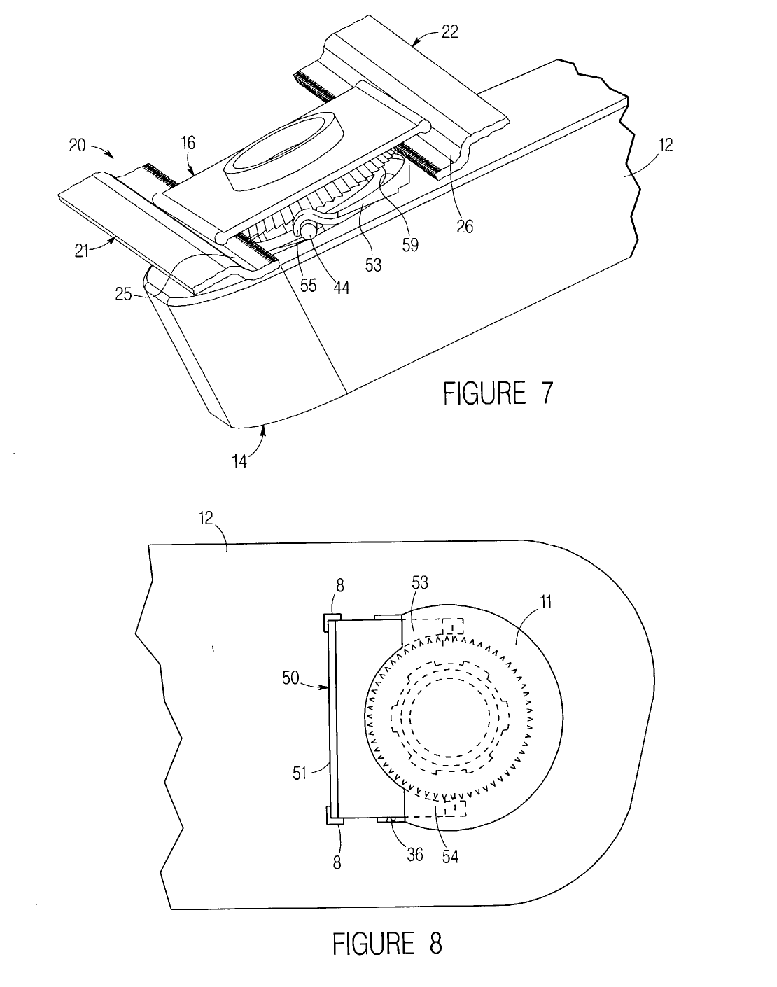

FIGS. 7 and 8 shown in detail the relationship of the actuator member 50, the arm support member 12, the locking member 40 and the track 20. In particular, it should be noted that the actuator member is located on one side of the arm support member 12 and the legs 53 and 54 of the actuator member extend through the passage 36 of the arm support member 12 to engage the extension members 44 and 45 of the locking member 40 on the opposite side of the arm support member 12 to move the locking member 40 on the extension member 30 while the arm support member 12 remains engaged with the track 20 via the connection between the extension member 30 and the slider 16. In this arrangement, the actuator member 50 and the locking member 40 operate in a manner substantially similar to a throw out bearing. The armrest is placed into and out of engagement with the track 20 via the linear motion of the locking member 40.

In operation, when a user or operator wants to adjust the vertical or rotational position of the arm support member 12, the user moves the handle 62 which in turn pulls the cable 63 causing the actuator member 50 to pivot with respect to the arm support member 12 and the extension member 30. As the actuator member 50 pivots the legs 53 and 54 which capture the extension members 44 and 45 of the locking member 40 cause the locking member 40 to translate on the extension member 30 due to the splined engagement there between. When the locking member 40 moves a sufficient distance, the teeth 41 of the locking member 40 are removed from the teeth 23 and 24 of the racks 21 and 22, respectively, of the track 20 thereby releasing the arm support member 12 to be either rotated, as supported by the engagement of the second extension portion 33 in the hole 19 in the slider 16, or moved along the track 20 as supported by the locking portion 34 connection between the extension member 30 and the slider 16. via the rounded edges 17 and 18 sliding on dwells 25 and 26 respectively.

In the present embodiment, it is possible to further include additional biasing members or means (not shown) being connected between the seat and the slider 16 to bias the slider along the track 20 such that when the locking member 40 is removed from engaging the track 20, the second end 14 of the arm support member 12 is caused to move in a given direction.

While a preferred embodiment of the present invention has been described in connection with the illustrations, and various modifications thereto have been referred to in the written text, the present invention generally relates to the a novel arrangement for connecting a arm support member to a vehicle seat to provide for a low cost, highly efficient arm support device. Accordingly, the invention may be variously embodied using this basic principle without departing from its intended scope. The invention is therefore not to be limited to the materials, shapes, orientations and proportions illustrated and described, but it is to be limited solely by the scope of the claims which follow.

What is claimed is:

1. An adjustable armrest device, comprising:
a support member having a first side, a second side, and an extension member extending from the support member;
a locking member having an inner surface and a toothed outer surface, the locking member being rotationally fixed with the extension member of the support member;
a track having a pair of toothed racks for cooperating with the toothed outer surface of the ring gear and a slider having a hole therein, the slider being movable on the track and having the extension member located in the hole in the slider; and
an actuator member having a first portion and a second portion connected to the locking member for moving the locking member between a first position in which the teeth of the locking member engage the toothed racks and a second position in which the teeth of the locking member are disengaged from the toothed racks and the support member may be rotated or translated along the track.

2. The adjustable armrest device of claim 1 wherein the actuator member comprises a pivot portion located between the first portion and the second portion.

3. The adjustable armrest device of claim 1 wherein the second portion of the actuator member comprises a first leg, a second leg spaced from the first leg, and a shaped edge located between the first leg and the second leg, the shaped edge being located proximate the extension member.

4. The adjustable armrest device of claim 1 wherein the locking member has a first extension member and a second extension member located substantially opposite the first extension member, the first and second extension members extending beyond the outer surface of the locking member and engaging the actuator member.

5. The adjustable armrest device of claim 1 wherein the outer surface of the locking member is angled such that the locking member has a frusto-conical shape.

6. The adjustable armrest device of claim 1 wherein the inner surface of the locking member includes a plurality of splines and the outer surface of the extension member includes a plurality of splines for engagement with the plurality of splines on the inner surface of the locking member.

7. The adjustable armrest device of claim 1 further comprising a biasing member positioned on the extension member for biasing the locking member into engagement with the track.

8. The adjustable armrest device of claim 7 wherein the biasing member is a compression coil spring.

9. The adjustable armrest device of claim 1 further comprising an operating member having a first end operatively connected to the actuator member and a second end having a handle, wherein when an operator moves the handle the first end of the operating member moves the actuator member causing the locking member to disengage from the track.

10. An adjustable armrest device for connection to a vehicle seat, the armrest device comprising:
an armrest support member having a first end and a second end spaced from the first end, the second end having an extension member having a first splined extension portion and a second cylindrical extension portion for connection with a slider in the vehicle seat;
a locking member having a splined hole having the first splined extension portion matingly engaged therein, the locking member having a peripheral surface having at least one locking notch thereon for locking the position of the locking member with respect to a track in the vehicle seat;
a biasing member for applying a biasing force to the locking member to force the at least one locking notch of the peripheral surface of the locking member into engagement with the track; and
an actuator member pivotally contacting the armrest support member, the actuator member having a first leg for capturing the first extension member of the locking member and a second leg for capturing the second extension member of the locking member, the actuator member being pivotable such that pivotal movement of the actuator translates the locking member on the extension member; wherein when the notch is withdrawn from the track, the armrest support member can rotate and translate with respect to the vehicle seat.

11. The adjustable armrest device of claim 10 wherein the locking member has a first extension member and a second extension member located opposite the first extension member, the first and second extension members extending beyond the peripheral surface of the locking member.

12. The adjustable armrest device of claim 10 wherein the biasing member is positioned on the extension member and has at least one portion located between the locking member and the armrest support member.

13. The adjustable armrest device of claim 12 wherein the biasing member is a coil spring loaded in compression.

14. The adjustable armrest device of claim 10 further comprising an operating member located at the first end of the armrest support member and operably connected to the actuator member for operating the actuator member.

15. The adjustable armrest device of claim 14 wherein the operating member comprises a handle connected to the first end of the armrest support member and a cable interconnecting the handle and the actuator member such that movement of the handle results in a pivoting of the actuator member.

16. An adjustable armrest support, comprising:
an armrest support member having a first side, a second side, and an extension member extending from the armrest support member, the extension member having a first cylindrical extension portion having a splined outer peripheral surface, the extension member having a second cylindrical extension portion extending form the first cylindrical extension portion;
a locking member having a splined inner surface and a toothed outer surface, the locking member being located on the first cylindrical extension portion, the locking member having a toothed peripheral surface;
a track having a first and a second toothed rack for mating engagement with the toothed outer surface of the locking member, each toothed rack having a longitudinal extent and a dwell extending in the longitudinal direction;
a biasing member for applying a biasing force to the locking member to force the locking member into engagement with the track;
a slider connected to the second cylindrical extension member, the slider having a first and second sides each having a substantially rounded shape adapted to be received in the dwell of the respective toothed rack; and
an actuator member connected to the locking member for moving the locking member between a first position in which the toothed outer surface of the locking member engages the first and second toothed racks of the track and a second position in which the toothed outer surface of the locking member is disengaged from the first and second toothed racks to allow the armrest support member to move with respect to the track.

17. The adjustable armrest support of claim 16 wherein the extension member is connected to the armrest support member at a first recessed portion defining a passage in the armrest support member proximate the extension member; and
wherein the actuator member includes a first portion and first and second legs, the first and second legs extending substantially perpendicular to the first portion and into the passage in the armrest support member to engage the locking member.

18. The adjustable armrest support of claim 17 wherein the locking member comprises first and second extension members aligned substantially opposite one another and each extending beyond the toothed outer surface of the locking member and having a substantially rounded outer surface; and
wherein the first leg of the actuator member has a hook member located at an end thereof for capturing the first extension member of the locking member and the second leg of the actuator member has a hook member located at an end thereof for capturing the second extension member of the locking member.

19. The adjustable armrest support of claim 16 further comprising an operating member located at the first end of the armrest support member and operably connected to the actuator member for operating the actuator member

20. The adjustable armrest support of claim 18 wherein the operating member comprises a handle connected to the first end of the armrest support member and a cable interconnecting the handle and the actuator member such that movement of the handle results in a pivoting of the actuator member.
